(19) United States
(12) Patent Application Publication
(10) Pub. No.: US 2023/0146189 A1
(43) Pub. Date: May 11, 2023

(54) Apparatus and methods for determining illegal deliveries in cricket

(71) Applicant: Mandar A. Joshi, Lutz, FL (US)

(72) Inventor: Mandar A. Joshi, Lutz, FL (US)

(73) Assignee: Mandar A. Joshi, Lutz, FL (US)

(21) Appl. No.: 17/980,036

(22) Filed: Nov. 3, 2022

Related U.S. Application Data
(60) Provisional application No. 63/263,883, filed on Nov. 10, 2021.

(51) Int. Cl. G06T 7/77; G06V 20/40; G06V 10/22

(52) U.S. Cl. CPC G06T 7/77; G06V 20/42; G06V 10/225; G06V 2201/07; G06T 2207/30224

(57) ABSTRACT

The technical solutions described herein pertain to apparatus and methods for accurately determining in cricket whether a ball is above the waist, shoulder, or head of a batter standing upright at the popping crease. Thus, certain embodiments of the technical solutions described herein provide apparatus and methods for accurately determining in cricket whether a ball is a no-ball, a wide-ball, or a legal ball. Certain embodiments of the technical solutions described herein also pertain to determining whether a legal ball is a bouncer. Particularly, the technical solutions described herein provide apparatus and methods for objectively determining in cricket whether a ball is a no-ball, a wide-ball, or a legal ball.

### BACKGROUND

The advent of ball-tracking technologies has made decision-making in sporting events significantly more accurate. Ball-tracking technologies have negated many incorrect umpiring calls and provided for fairer outcomes. For example, in cricket, leg-before-wicket decisions are often reviewed using ball-tracking and umpiring errors are corrected, or prevented.

### SUMMARY

Certain embodiments of the technical solutions described herein provide systems, apparatuses, and methods for accurately determining in cricket whether a ball is above the waist, shoulder, or head of a batter standing upright at the popping crease. Thus, certain embodiments of the technical solutions described herein provide systems, apparatuses, and methods for accurately determining in cricket whether a ball is a no-ball, wide-ball, legal bouncer, legal non-bouncer, etc.

As noted above, such decisions are conventionally made subjectively by a third-umpire. Because the technical solutions described herein provide systems, apparatuses, and methods for objective determination in such instances, more accurate and error free decisions can be made.

### BRIEF DESCRIPTION OF THE DRAWINGS

FIG. 1: A flow-chart of the workings of an embodiment of the systems, methods, and apparatuses disclosed herein.

FIG. 2: A block-diagram of various elements of an embodiment of the systems, methods, and apparatuses disclosed herein.

### DETAILED DESCRIPTION

As of 2021, the cricket rules state that any delivery, which passes or would have passed, without pitching, above waist height of the striker standing upright at the popping crease, is unfair, i.e., illegal. Whenever such a delivery is bowled, the umpire shall call and signal “no-ball.” Similarly, in certain situations, the umpire shall call and signal “no-ball” for a delivery which, after pitching, passes or would have passed over head height of the batter standing upright at the popping crease. In other situations, a ball that passes above head height of the striker (when standing upright) shall be called a wide-ball.

In cricket, while many objective observations, such as “a ball pitching outside leg stump,” are conclusively made using ball-tracking technologies, decisions for no-balls and wide-balls for height are reviewed by a third umpire, who makes a decision in a subjective manner. Particularly, a third umpire reviews the actual video of the incidence and tries to determine the height of the ball and conclude whether it was above waist, shoulder, or head of the batter. Often, such determination is muddled by the batter running down the pitch or not standing upright. Therefore, such decisions are not made in the most accurate manner.

Technical challenge exists to make such objective decisions about the legality of a ball that has been delivered. For example, the legality of the ball changes depending on the batter facing the ball because different batters have different heights. Further, the legality of the ball changes as the batter moves forward/backward on the pitch. Because several variable factors are introduced, present solutions rely on the subjectivity of the third umpire to review video footage of the ball to make the decision. Along with the subjectivity, the present solution results in a delay of the game, where the players, spectators, etc. have to wait until the third umpire reviews and makes his/her decision.

Technical solutions described herein address such technical challenges and provide practical applications to improve the decision-making in determining the legality of the ball that has been delivered. The technical solutions provide a practical application by providing a real-time objective decision about the legality of the ball that is delivered based on analysis of video footage/images of the ball. Accordingly, one or more aspects of the technical solutions described herein improve the game of cricket, and particularly adjudication of the rules of the game of cricket in real-time. The improvement also includes providing an objective adjudication that is missing at present when the adjudication is done by a human in a subjective manner. It would not be possible, and at least not practical, for a human to perform such an objective analysis in real-time by analyzing video footage of the ball that is delivered.

### Methods

Certain embodiments of the technical solutions described herein provide an automated method for determining in cricket whether a ball bowled to a batter is a no-ball, the method comprising:
a) receiving tracked and/or predicted path for the ball at least beyond the popping crease,
b) comparing a known height of the batter's waist, shoulder, or head with the height of the ball as it passed or would have passed the popping crease, and
c) determining whether the ball is a no-ball based on the comparison made in step b).

Certain embodiments of the technical solutions described herein provide an automated method for determining in cricket whether a ball bowled to a batter is a wide-ball, the method comprising:
a) receiving tracked and/or predicted path for the ball at least beyond the popping crease,
b) comparing a known height of the batter's head with the height of the ball as it passed or would have passed the popping crease, and
c) determining whether the ball is a wide-ball based on the comparison made in step b).

Certain embodiments of the technical solutions described herein provide an automated method for determining in cricket whether a ball bowled to a batter is a bouncer, the method comprising:
a) receiving tracked and/or predicted path for the ball at least beyond the popping crease,
b) comparing a known height of the batter's shoulder with the height of the ball as it passed or would have passed the popping crease, and
c) determining whether the ball is a bouncer-ball based on the comparison made in step b).

The ball-tracking technology can be a part of the system that also comprises the system according to the technical solutions described herein. Alternatively, a ball-tracking technology can be separately run and the tracked and/or predicted path for the ball at least beyond the popping crease can be received from such separate system by the system of the technical solutions described herein.

Popping crease defines popping crease is a line that runs horizontally across a cricket pitch, four feet in front of the stumps. The phrase “at least beyond the popping crease” as used herein refers to the region beyond the popping crease and towards the stumps at the batter's end.

The ball-tracking technologies are well-known in the art. In cricket, the most commonly used example of ball-tracking technology is Hawk-Eye™. Hawk-Eye™ technology involves the use of six or more computer-linked television cameras situated around the cricket field of play. The computer reads in the video in real time, and tracks the path of the cricket ball on each camera. These six separate views are then combined together to produce an accurate 3D representation of the path of the ball. It should be noted that ball-tracking can be performed using any known or later-developed technique(s) without affecting the technical solutions described herein. Examples described herein may use Hawk-Eye™ as one possible implementation of the several possible ball-tracking techniques.

According to one or more aspects of technical solutions described herein the information received from a ball-tracking technology, such as Hawk-Eye™ to more accurately determine the height of the ball as it passed or would have passed the popping crease relative to the waist, head, or shoulder height of the batter.

To that end, the waist, shoulder, and head height of every batter participating in a match is obtained. This information is used in an individualized manner to decide the height of the ball as it passed or would have passed the popping crease relative to the waist, head, or shoulder height of the batter facing the ball.

For example, if batter A is facing bowler B, the delivery is tracked by the Hawk-Eye™. The height at which the delivery passes or would have passed the popping crease, with or without pitching, is compared to the known waist, shoulder, or head height of batter A. This negates from the analysis whether batter A was down the pitch to play the delivery and/or is crouching to play the delivery thereby obscuring the proper assessment of batter A's waist, shoulder, or head height. Thus, the height at which the delivery passes or would have passed the popping crease, with or without pitching, as observed or predicted by the ball-tracking technology would be objectively compared with the known waist, shoulder, or head height of batter A. Accordingly, the delivery can be precisely called a no-ball or a wide-ball as the case may be.

The call for no-ball or wide-ball could be made according to the pre-set or preferred rule. For example, a no-ball or a wide-ball may only be called if the entirety of the ball passed or would have passed above the known waist, shoulder, or head height of a batter. Alternatively, a no-ball or a wide-ball may only be called if any part of the ball passed or would have passed above the known waist, shoulder, or head height of a batter. In a further option, a no-ball or a wide-ball may only be called if at least half of the ball passed or would have passed above the known waist, shoulder, or head height of a batter. Such rules can be set before the match is played by the participating teams or the organization conducting the game.

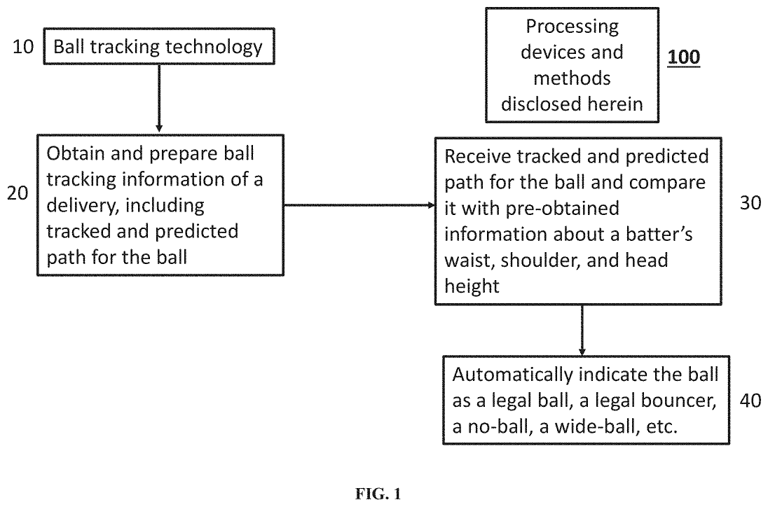

FIG. 1 describes a flow-chart of the workings of an embodiment of the systems, methods, and apparatuses disclosed herein. The embodiment (100) comprises a ball-tracking technology (10), which tracks and/or predicts the path for the ball at least beyond the popping crease. The part (20) of the system (100) according to the technical solutions described herein receives from the ball-tracking technology (10) the ball-tracking information of a delivery, including tracked and/or predicted path for the ball. The part (30) compares the received tracked and/or predicted path for the ball with pre-obtained information about a batter's waist, shoulder, and head height. The part (40) automatically indicates the ball as a legal-ball, a legal-bouncer, a no-ball, a wide-ball, etc.

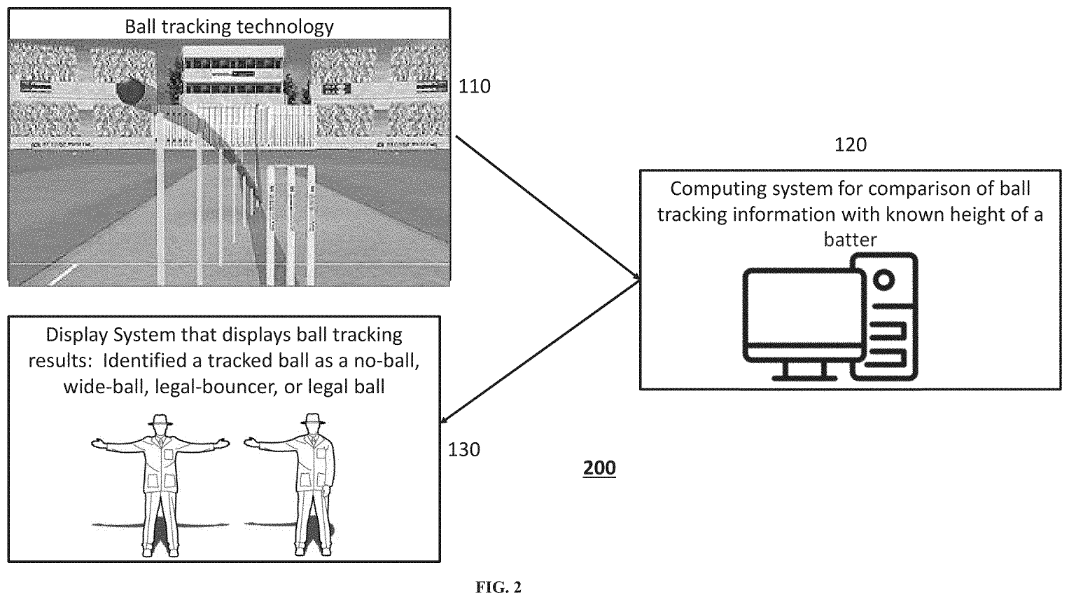

FIG. 2 describes a block-diagram of various elements of an embodiment of the systems, methods, and apparatuses disclosed herein.

The embodiment (200) comprises a ball-tracking technology (110), which tracks and/or predicts the path for the ball at least beyond the popping crease.

The computing system (120) receives from the ball-tracking technology (110) the ball-tracking information of a delivery, including tracked and/or predicted path for the ball. The computing system (120) also compares the received tracked and/or predicted path for the ball with pre-obtained information about a batter's waist, shoulder, and head height.

The display system (130) automatically indicates the ball as a legal-ball, a legal-bouncer, a no-ball, a wide-ball, etc. The display system can be a monitor, projector screen, television screen, or any other appropriate screen.

Computer Readable Media

The technical solutions described herein include computer readable medium, including non-transitory computer readable medium, which stores instructions for carrying out the methods disclosed herein. Aspects of the technical solutions described herein include computer readable medium storing instructions that, when executed by a computing device, cause the computing device to perform one or more of the steps of the methods disclosed herein.

In some instances, a computer readable medium described herein stores instructions that cause a computing device to perform one or more of the steps of the methods disclosed herein.

For example, in some instances, a computer readable medium described herein stores instructions that cause a computing device to:
a) receive tracked and/or predicted path for the ball at least beyond the popping crease,
b) compare a known height of the batter's waist, shoulder, or head with the height of the ball as it passed or would have passed the popping crease, and
c) determine whether the ball is a no-ball based on the comparison made in step b).

In some instances, a computer readable medium described herein stores instructions that cause a computing device to perform one or more of the steps of the methods disclosed herein. For example, in some instances, a computer readable medium described herein stores instructions that cause a computing device to:
a) receive tracked and/or predicted path for the ball at least beyond the popping crease,
b) compare a known height of the batter's head with the height of the ball as it passed or would have passed the popping crease, and
c) determine whether the ball is a wide-ball based on the comparison made in step b).

In some instances, a computer readable medium described herein stores instructions that cause a computing device to perform one or more of the steps of the methods disclosed herein. For example, in some instances, a computer readable medium described herein stores instructions that cause a computing device to:
a) receive tracked and/or predicted path for the ball at least beyond the popping crease,
b) compare a known height of the batter's shoulder with the height of the ball as it passed or would have passed the popping crease, and
c) determine whether the ball is a bouncer-ball based on the comparison made in step b).

In certain embodiments, instructions in accordance with the methods described herein can be coded onto a computer-readable medium in the form of “programming”, where the term “computer readable medium” as used herein refers to any storage or transmission medium that participates in providing instructions and/or data to a computer for execution and/or processing. Examples of storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on computer readable medium, where “storing” means recording information such that it is accessible and retrievable at a later date by a computer.

The computer-implemented method described herein can be executed using programming that can be written in one or more of any number of computer programming languages. Such languages include, for example, Java (Sun Microsystems, Inc., Santa Clara, Calif.), Visual Basic (Microsoft Corp., Redmond, Wash.), and C++ (AT&T Corp., Bedminster, N.J.), as well as any many others.

### EXAMPLES

The following examples are put forth so as to provide those of ordinary skill in the art with a complete disclosure and description of how to make and use the technical solutions described herein, and are not intended to limit the scope of what the inventor regards as the technical solutions described herein nor are they intended to represent that the experiments below are all or the only experiments performed.

### Example 1—Accurately Determining a No-Ball Bowled to Batter A by Bowler B

Batter A has waist at a height at 43 inches from the ground level, has shoulder at a height of 60 inches from the ground level, and has the top of the head at 72 inches from the ground level.

Bowler B bowls a ball, which does not pitch before reaching the batter and goes to the keeper. A ball-tracking technology tracks the path of the ball. Such information is received by a system disclosed herein, which determines that the height of the ball as it passed the popping crease was more than 43 inches from the ground. Therefore, the system disclosed herein objectively determines that the ball passed above the waist of the batter standing upright at the popping crease. The system disclosed herein automatically determines and indicates that the ball was a no-ball.

In another situation, bowler B bowls a ball, which does not pitch before reaching the batter and goes to the keeper. A ball-tracking technology tracks the path of the ball. Such information is received by a system disclosed herein, which determines that the height of the ball as it passed the popping crease was less than 43 inches from the ground. Therefore, the system disclosed herein objectively determines that the ball passed below the waist of the batter standing upright at the popping crease. The system disclosed herein automatically indicates that the ball was not a no-ball.

### Example 2—Accurately Determining a No-Ball Bowled to Batter A by Bowler B

Batter A has waist at a height at 43 inches from the ground level, has shoulder at a height of 60 inches from the ground level, and has the top of the head at 72 inches from the ground level.

Bowler B bowls a ball, which does not pitch before reaching the batter but the batter hits the ball before the ball crosses the popping crease. A ball-tracking technology tracks the path of the ball and projects the path of the ball if the ball was not hit by the batter. A system disclosed herein received the tracking information from the tracking technology and determines that the height of the ball as it would have passed the popping crease was more than 43 inches from the ground. Therefore, the system disclosed herein objectively determines that the ball would have passed above the waist of the batter standing upright at the popping crease. The system disclosed herein automatically indicates that the ball was a no-ball.

In another situation, bowler B bowls a ball, which does not pitch before reaching the batter and the batter hits the ball before it crosses the popping crease. A ball-tracking technology tracks the path of the ball and projects the path of the ball if the ball was not hit by the batter. A system disclosed herein received the ball-tracking information from the ball-tracking technology and determines that the height of the ball as it would have passed the popping crease was less than 43 inches from the ground. Therefore, the system disclosed herein objectively determines that the ball would have passed below the waist of the batter standing upright at the popping crease. The system disclosed herein automatically indicates that the ball was not a no-ball.

### Example 3—Accurately Determining a No-Ball Bowled to Batter A by Bowler B

Batter A has waist at a height at 43 inches from the ground level, has shoulder at a height of 60 inches from the ground level, and has the top of the head at 72 inches from the ground level.

Bowler B had bowled the allotted quota of the bouncers in that over. Bowler B bowls a ball, which pitches before reaching the batter and goes to the keeper. A ball-tracking technology tracks the path of the ball. A system disclosed herein received the ball-tracking information from the ball-tracking technology and determines that the height of the ball as it passed the popping crease was more than 60 inches from the ground. Therefore, the system disclosed herein objectively determines that the ball passed above the shoulder of the batter standing upright at the popping crease. The system disclosed herein automatically indicates that the ball was a no-ball.

Bowler B had bowled the allotted quota of the bouncers in that over. In another situation, bowler B bowls a ball, which pitches before reaching the batter and goes to the keeper. A ball-tracking technology tracks the path of the ball. A system disclosed herein received the ball-tracking information from the ball-tracking technology and determines that the height of the ball as it passed the popping crease was less than 60 inches from the ground. Therefore, the system disclosed herein objectively determines that the ball passed below the shoulder of the batter standing upright at the popping crease. The system disclosed herein automatically indicates that the ball was not a no-ball.

### Example 4—Accurately Determining a No-Ball Bowled to Batter A by Bowler B

Batter A has waist at a height at 43 inches from the ground level, has shoulder at a height of 60 inches from the ground level, and has the top of the head at 72 inches from the ground level.

Bowler B had bowled the allotted quota of the bouncers in that over. Bowler B bowls a ball, which does pitches before reaching the batter but the batter hits the ball before the ball crosses the popping crease. A ball-tracking technology tracks the path of the ball and projects the path of the ball if the ball was not hit by the batter. A system disclosed herein received the ball-tracking information from the ball-tracking technology and determines that the height of the ball as it would have passed the popping crease was more than 60 inches from the ground. Therefore, the system disclosed herein objectively determines that the ball would have passed above the shoulder of the batter standing upright at the popping crease. The system disclosed herein automatically indicates that the ball was a no-ball.

Bowler B had bowled the allotted quota of the bouncers in that over. In another situation, bowler B bowls a ball, which pitches before reaching the batter and the batter hits the ball before it crosses the popping crease. A ball-tracking technology tracks the path of the ball and projects the path of the ball if the ball was not hit by the batter. A system disclosed herein received the ball-tracking information from the ball-tracking technology and determines that the height of the ball as it would have passed the popping crease was less than 60 inches from the ground. Therefore, the system disclosed herein objectively determines that the ball would have passed below the waist of the batter standing upright at the popping crease. The system disclosed herein automatically indicates that the ball was not a no-ball.

### Example 5—Accurately Determining a Wide-Ball Bowled to Batter A by Bowler B

Batter A has waist at a height at 43 inches from the ground level, has shoulder at a height of 60 inches from the ground level, and has the top of the head at 72 inches from the ground level.

Bowler B bowls a ball, which pitches before reaching the batter and goes to the keeper. A ball-tracking technology tracks the path of the ball. A system disclosed herein receives the tracking information from the ball-tracking technology and determines that the height of the ball as it passed the popping crease was more than 72 inches from the ground. Therefore, the system disclosed herein objectively determines that the ball passed above the head of the batter standing upright at the popping crease. The system disclosed herein automatically indicates that the ball was a wide-ball.

In another situation, bowler B bowls a ball, which pitches before reaching the batter and goes to the keeper. A ball-tracking technology tracks the path of the ball. A system disclosed herein received the ball-tracking information from the ball-tracking technology and determines that the height of the ball as it passed the popping crease was less than 72 inches from the ground. Therefore, the system disclosed herein objectively determines that the ball passed below the shoulder of the batter standing upright at the popping crease. The system disclosed herein automatically indicates that the ball was not a no-ball.

### Example 6—Accurately Determining a Bouncer Bowled to Batter A by Bowler B

Batter A has waist at a height at 43 inches from the ground level, has shoulder at a height of 60 inches from the ground level, and has the top of the head at 72 inches from the ground level.

Bowler B had not bowled the allotted quota of the bouncers in that over. Bowler B bowls a ball, which pitches before reaching the batter and goes to the keeper. A ball-tracking technology tracks the path of the ball. A system disclosed herein received the ball-tracking information from the ball-tracking technology and determines that the height of the ball as it passed the popping crease was more than 60 inches but less than 72 inches from the ground. Therefore, the system disclosed herein objectively determines that the ball passed above the shoulder but below the head of the batter standing upright at the popping crease. The system disclosed herein automatically indicates that the ball was a bouncer.

Bowler B had not bowled the allotted quota of the bouncers in that over. In another situation, bowler B bowls a ball, which pitches before reaching the batter and goes to the keeper. A ball-tracking technology tracks the path of the ball. A system disclosed herein received the ball-tracking information from the ball-tracking technology and determines that the height of the ball as it passed the popping crease was less than 60 inches from the ground. Therefore, the system disclosed herein objectively determines that the ball passed below the shoulder of the batter standing upright at the popping crease. The system disclosed herein automatically indicates that the ball was not a bouncer.

1. A computer-implemented method for determining in a cricket match whether a ball bowled to a batter is a no-ball, a wide-ball, or a legal ball, the computer-implemented method comprising:
a) receiving tracked and/or predicted path for the ball at least beyond the popping crease,
b) comparing a known height of the batter's waist, shoulder, or head with a height of the ball as it passed or would have passed the popping crease, and
a) determining whether the ball is a no-ball, wide-ball, or a legal ball based on the comparison made in step b).

2. The method of claim 1, comprising determining that the legal ball is a bouncer.

3. The method of claim 1, comprising determining that the ball is a no-ball.

4. The method of claim 1, comprising determining that the ball is a wide-ball.

5. The method of claim 1, wherein the ball-tracking technology is Hawk-Eye™.

6. The method of claim 1, wherein the waist, shoulder, and head height of every batter participating in the cricket match is obtained prior to the beginning of the cricket match, and is accessible electronically.

7. A non-transitory computer readable medium comprising instructions that, when executed by a computing device, cause the computing device to:
a) receive tracked and/or predicted path for the ball at least beyond the popping crease,
b) compare a known height of the batter's waist, shoulder, or head with the height of the ball as it passed or would have passed the popping crease, and
c) determine whether the ball is a no-ball, wide-ball, or a legal ball based on the comparison made in step b).

8. The non-transitory computer readable medium of claim 7, comprising instructions that, when executed by the computing device, cause the computing device to determine that the legal ball is a bouncer.

9. The non-transitory computer readable medium of claim 7, comprising instructions that, when executed by the computing device, cause the computing device to determine that ball is a no-ball.

10. The non-transitory computer readable medium of claim 7, comprising instructions that, when executed by the computing device, cause the computing device to determine that ball is a wide-ball.

11. The non-transitory computer readable medium of claim 7, comprising instructions that, when executed by the computing device, cause the computing device to receive tracked and/or predicted path for the ball at least beyond the popping crease from Hawk-Eye™.

12. The non-transitory computer readable medium of claim 7, further comprising the information about the waist, shoulder, and head height of every batter participating in the cricket match.

13. A system comprising:
a memory device; and
one or more processors coupled with the memory device, the one or more processors are configured to perform a method of analyzing, during a game of cricket, legality of a ball that is delivered, the method comprising:
computing a predicted height of the ball that is delivered at a timepoint when the ball is projected to pass a predetermined location on a pitch;
comparing the predicted height with a plurality of predetermined thresholds, the predetermined thresholds are based on an identity of a batter facing the ball; and
outputting the legality of the ball that is delivered based on the comparison.
